(19) United States
(12) Patent Application Publication
(10) Pub. No.: US 2020/0076029 A1
(43) Pub. Date: Mar. 5, 2020

(54) METHOD FOR THE CLIMATE CONTROL OF A BATTERY ELECTRIC VEHICLE

(71) Applicant: FORD GLOBAL TECHNOLOGIES, LLC, Dearborn, MI (US)

(72) Inventor: Armin LITZ, Cologne (DE)

(73) Assignee: FORD GLOBAL TECHNOLOGIES, LLC, Dearborn, MI (US)

(21) Appl. No.: 16/552,267

(22) Filed: Aug. 27, 2019

(30) Foreign Application Priority Data
Aug. 30, 2018 (DE) 10 2018 214 736.1

(51) Int. Cl. H01M 10/66; B60L 58/26; B60L 58/27; H01M 2/10; H01M 10/6568; H01M 10/625; H01M 10/63; B60H 1/00; B60H 1/22; B60H 1/14; B60H 1/32

(52) U.S. Cl. CPC H01M 10/66; H01M 2220/20; B60L 58/27; H01M 2/1094; H01M 10/6568; H01M 10/625; H01M 10/63; B60H 1/00007; B60H 1/00278; B60H 1/00392; B60H 1/00642; B60H 1/2218; B60H 1/143; B60H 1/3222; B60H 1/3229; B60L 2240/36; B60L 58/26

(57) ABSTRACT

An electric vehicle and method for controlling an electric vehicle such as a bus include climate control of a traction or drive battery and using thermal mass or capacity of the traction battery for climate control of the vehicle cabin. The drive battery is double insulated with respect to the surroundings and kept within a desired temperature range by means of a temperature control including a cooling medium flowing around the battery. An electrical heating system for the cooling medium, an electrical compressor, and an evaporator/condenser for the cooling medium are controlled by a control system. A climate control for the passenger compartment is coupled to the temperature control by way of a heat exchanger to be supplied with heat or cold from the battery or its cooling medium.

### CROSS-REFERENCE TO RELATED APPLICATIONS

This application claims foreign priority benefits under 35 U.S.C. § 119(a)-(d) to DE Application 10 2018 214 736.1 filed Aug. 30, 2018, which is hereby incorporated by reference in its entirety.

### TECHNICAL FIELD

This disclosure relates to a method for the climate control of a battery and cabin of a battery electric vehicle, such as a bus.

### BACKGROUND

It is known that one consideration in the case of battery electric vehicles is to keep the temperature of the battery within a certain range to optimize its capacity. In other words, the battery must be neither too cold nor too warm. In winter, the battery must therefore be warmed and in summer, or when it is severely loaded, it must be cooled.

In the case of conventional vehicles driven by an internal combustion engine, the climate control of the passenger cabin is performed by air conditioning systems, which obtain the required heat from the waste heat of the combustion engine and provide the cooling capacity by using increased shaft output of the engine for driving compressors.

In the case of battery electric vehicles, the waste heat for heating up the passenger cabin that otherwise comes from the internal combustion engine is not available to the same extent either directly or indirectly. Additional shaft outputs for operating compressors are in this case at the expense of the capacity of the battery.

Therefore, the components of the air conditioning system (compressor, evaporator, etc.) are operated electrically by means of the battery. However, this is to the detriment of the battery capacity, since therefore a considerable proportion of the energy that is actually required for the range of the vehicle is lost. In the case of buses, this proportion far exceeds that of normal motor vehicles.

WO 2008/127527 A1 discloses a thermal management system for battery electric vehicles in which the cooling of the drive train, temperature control of the battery, and the air conditioning system are connected by a common heat exchanger to a cooling circuit. The air conditioning system and the temperature control of the battery each additionally have an electrical heating system.

### SUMMARY

According to one or more embodiments, it has been realized by the present inventors that it is possible to control the climate of the passenger compartment successfully even without a classic air conditioning system having a powerful compressor. A climate control of a battery electric vehicle, in particular a bus, includes a highly insulated drive battery, which is kept constantly within a temperature range by means of a temperature control. The temperature control comprises a cooling medium flowing around the battery, an electrical heating system for the cooling medium, and an electrical compressor and an evaporator for the cooling medium. A control system operates in cooperation with a climate control for the passenger compartment, which is coupled to the temperature control by way of a heat exchanger to be supplied with heat or cold from the battery or its cooling medium.

It has been realized that the mass of the drive battery required for large battery electric vehicles, in particular that of a bus, has a very great heat or cold capacity. The high level of insulation according to embodiments of the present disclosure allows it to be kept in an optimum temperature range, which is desirable in any case for its operation. As a result, however, a heat or cold capacity is also available, and can be used for the climate control of the passenger compartment. Especially in the case of larger battery electric vehicles, the thermal mass of the drive battery is so great that it has sufficient heat or cold capacity for this heat or cold capacity to be usable.

A bus is considered to be a motor vehicle with 6 to 20 places for passengers. It goes without saying that embodiments according to the disclosure can provide advantages particularly well here because corresponding drive batteries have high masses. In addition, larger vehicles generally have more cabin space that can be used to further insulate a drive battery contained therein. However, various embodiments can in principle also be applied to other battery electric vehicles, such as passenger cars or trucks.

In other words, the climate control of the passenger compartment is only supplied with heat or cold from the drive battery.

The drive battery is in this case insulated within an insulated cabin (therefore is double-insulated). As a result, the drive battery is insulated both by its insulation with respect to the interior space and also additionally by the special insulation of the interior space with respect to the surroundings.

In various embodiments, in cooperation with the good insulation of the drive battery, the passenger compartment itself is also insulated better than was previously usual. For this purpose, insulating glass or even laminated insulating glass is used for the windows and/or insulation of the body components, such as for example a heat and cold insulation of thick insulating nonwoven fabric (>2 cm), an insulating foam, and/or vacuum insulating panels. Therefore, even double glazing units according to DE 102018207569 A1 could be used, for example.

During the electrical charging, the drive battery itself may be cooled down to the target temperature range by way of the electrical compressor and evaporator/condenser or be heated up by means of a positive thermal coefficient (PTC) heating element. Therefore, during charging, if necessary the drive battery is returned completely to the desired temperature range or its heat or cold capacity is restored. In various embodiments the components used for this are outside the battery insulation, and in particular outside the insulation of the passenger compartment. In other words, the components are arranged where their waste heat or cold does not disturb the climate control of the passenger compartment. This could be in the possibly still present “engine compartment” or on the roof, etc.

The climate control of the passenger compartment may be by way of the heat exchanger and the air from the passenger compartment. Therefore, a common heat exchanger may be used to, on the one hand control the temperature of the drive battery, and on the other hand to use its heat or cold capacity for the passenger compartment. The temperature control of the drive battery and the climate control of the passenger compartment are therefore coupled to the extent that the high thermal capacity of the drive battery is used for the climate control of the passenger compartment, since the latter has a thermal capacity that is smaller by orders of magnitude, which has to be heated up or cooled down.

In other words, the drive battery acts as it were like the content of a chest freezer, that is to say an insulated system that has such a great thermal capacity that it can be used for controlling the climate of the passenger cabin.

For this purpose, it is advisable if only the evaporator for the cooling medium as part of the temperature control is arranged within the insulation of the drive battery. Consequently, on the one hand there can be better insulation (superinsulation) of the drive battery and on the one hand there can be simpler coupling or joint use of the temperature control components for the climate control of the passenger compartment.

If necessary for a particular application, the temperature control circuit may also comprise a cooling medium pump. The cooling medium may be a cooling liquid.

Because, in view of its position within a cabin which is in turn particularly insulated with respect to the surroundings, the insulated drive battery also transfers its losses principally to this insulated cabin, there is no need for continuous climate control of the passenger compartment in order to obtain a temperature of the passenger compartment that is in each case around the desired comfortable temperature. Therefore, even when boarding, a more pleasant climate can also be provided than if the drive battery were located outside the passenger compartment. The losses occurring therefore first and foremost benefit the compartment and are not lost directly to the surroundings.

Because charging of battery electric vehicles often occurs during the night, and the minimum night-time temperatures may differ by only a few Kelvin in various locations, in summertime the cooling of the battery is particularly effective during the night, since that is when there are the coldest likely ambient temperatures. Since the cooling time takes several hours, loading peaks are avoided. In wintertime, the night-time conditioning will result in the interior space experiencing the heat losses of the drive battery first, and therefore be warmer.

In various embodiments, the temperature range of the temperature control of the drive battery lies between 4 and 35 degrees Celsius. In other embodiments the temperature range is between 10 and 25 degrees Celsius and may be at or around 12 degrees Celsius, for example, or a temperature that is close to the minimum daytime temperatures in summer to provide sufficient heat for the interior space even in the transitional time. In wintertime, with extreme temperatures, the conditioning of the battery would take place in the range of 12 to 35 degrees Celsius. Consequently, sufficient thermal capacity is available for the usually required climate control wishes for the passenger compartment. At the same time, the drive battery can therefore be operated in a favorable temperature window, and in particular at the end of the day, when the battery capacity is exhausted, can lie in the range that is optimum for the battery, so that specifically then the highest battery capacity is available.

If it is found because of extreme heat or cold conditions that the heat or cold capacity of the drive battery with the desired or target set temperature control is not sufficient, the temperature range can be correspondingly changed in the downward or upward direction, in that the temperature control of the drive battery is adapted during charging. For this purpose, it may be provided in the control system of the vehicle that the respective temperatures of the passenger compartment, the drive battery and the target temperatures are tracked.

The temperature range may therefore be adapted on the basis of values from the climate control of previous periods.

Further details of the claimed subject matter emerge from the following description of representative embodiments on the basis of the drawings.

### BRIEF DESCRIPTION OF THE DRAWINGS

FIG. 1 shows a schematic side view of a passenger compartment of a bus, including indication of the drive battery and the climate control.

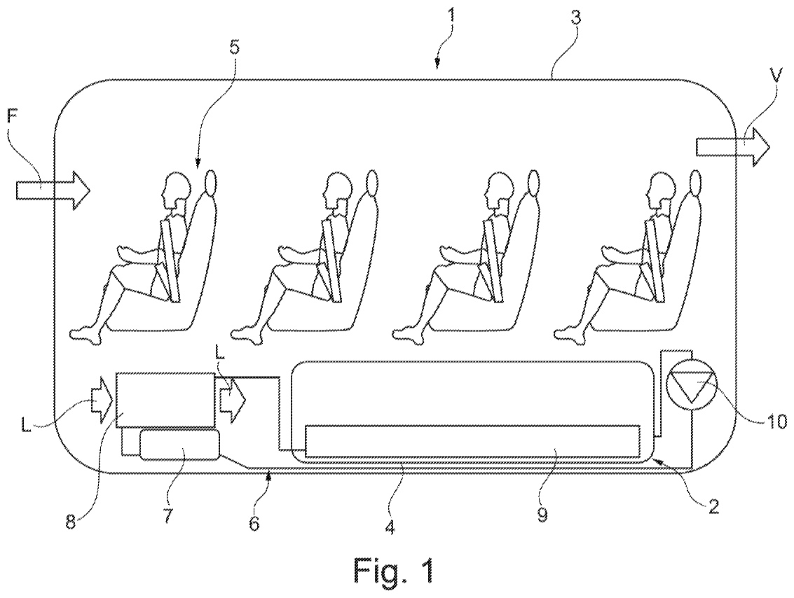

FIG. 2 shows the view from FIG. 1, including component parts in the cooling of the drive battery.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

Represented in the figures is a passenger compartment, denoted overall by 1, of a battery electric minibus with four rows of seats 5, which is provided with a thermal insulation 3.

Within the thermal insulation 3 of the passenger compartment 1, usually underneath, a large drive battery 2 (in the range of at least 1,000 kg) is arranged in a further insulation 4, which comprises an insulation that is selected based on the typical vehicle surroundings.

The drive battery 2 is connected to a heating and cooling circuit 6, which according to various embodiments also serves for the climate control of the passenger compartment 1, in that the high thermal capacity of the drive battery 2 is used.

The heating and cooling circuit 6 comprises components that are connected by corresponding lines and, by means of cooling liquid, use heat or cold from the drive battery 2 for the climate control.

The heat exchange for heating and for cooling the cabin takes place by way of a liquid cooling circuit 6 (comparable with the glycol-water coolant of internal combustion engines, with the difference that it can also cool). Integrated in this circuit is an electrical high-voltage PTC heating element 7, which for conditioning the drive battery in the night is operated without the blower motor to attain or maintain a desired battery temperature. Also included is a downstream heat exchanger 8, which is operated with the blower motor when the thermal exchange with the cabin air L of the passenger compartment 1 is desired, and comprises a heat exchanger 9, which is arranged within the battery insulation 4 or the cooling liquid flow thereof, and a circulating pump 10 for the cooling medium.

Therefore, by way of the heat exchanger 8, the coolant circuit 6 can, depending on the setting, warm or cool the air L of the passenger compartment 1 by using the thermal capacity of the drive battery 2.

If necessary, the temperature of the cooling liquid in the heating circuit 6 may be changed by means of the high-voltage PTC heating element 7. For the conditioning of the drive battery, the blower motor in this case remains switched off and only the water-side PTC element and the water pump remain switched on. Therefore, downstream of the water-side PTC element, warm water is returned for conditioning the drive battery. This setting should be used for conditioning the battery overnight when days are cold.

Since the drive battery 2 has a very great thermal capacity in comparison with the required amount of heat or cold, this capacity can be used for the climate control of the passenger compartment, without its temperature being changed substantially. The insulation of the cabin assists this process.

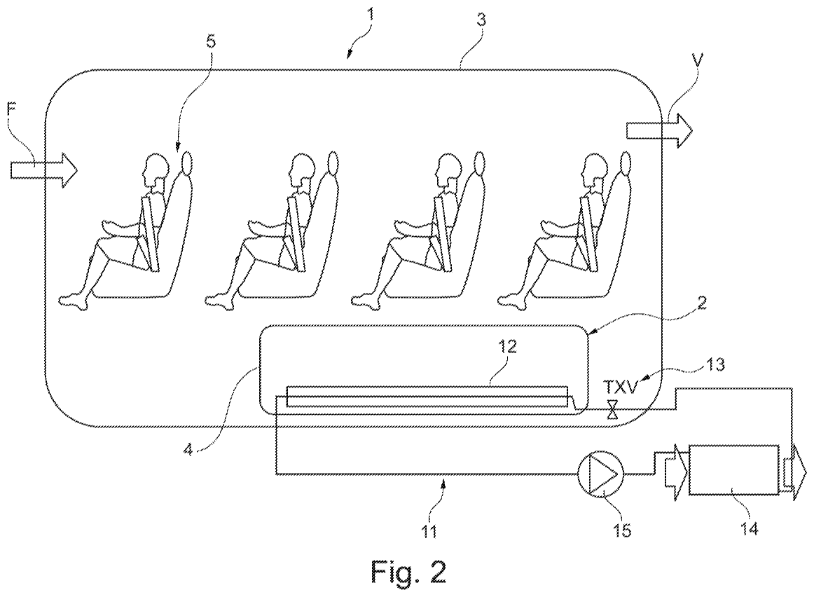

As can be seen from FIG. 2, the drive battery 2 is also provided with a refrigerant circuit 11, by means of which, during the electrical charging, the drive battery 2 can be brought back or cooled down to a desired temperature range, which is about 12 degrees Celsius in one embodiment. In various embodiments, the temperature range of the temperature control of the drive battery lies between 4 and 35 degrees Celsius. In other embodiments the temperature range is between 10 and 25 degrees Celsius and may be at or around 12 degrees Celsius, for example, or a temperature that is close to the minimum daytime temperatures in summer to provide sufficient heat for the interior space even in the transitional time.

The refrigerant circuit 11 comprises an evaporator 12, which is arranged within the battery insulation 4 or the coolant volume thereof, an expansion valve 13, a condenser 14 and also an electrical compressor 15, which by contrast with the evaporator 12 are arranged outside the passenger cabin insulation, so that their waste heat or cold can be exchanged in the surroundings.

The passenger compartment 1 may also have a supply of fresh air F and a removal V of stale air.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. An electric vehicle, comprising:
a thermally insulated passenger compartment;
a traction battery contained within a thermally insulated battery housing, the battery housing disposed within the thermally insulated passenger compartment;
a heating and cooling system configured to heat and cool both the traction battery and the passenger compartment, comprising:
an electric heating element;
a first heat exchanger disposed outside of the battery housing;
a blower motor configured to circulate air within the passenger compartment through the first heat exchanger;
a second heat exchanger disposed within the battery housing;
a fluid circuit coupled to the first and second heat exchangers and the electric heating element; and
a circulating pump configured to circulate a liquid through the fluid circuit;
and;
a controller configured to control the electric heating element, the blower motor, and the circulating pump of the heating and cooling system to warm or cool air within the passenger compartment using thermal capacity of the traction battery.

2. The electric vehicle of claim 1, wherein the controller is further configured to operate the circulating pump and electric heating element with the blower motor off when the battery is charging, and to operate the circulating pump with the blower motor on to maintain cabin temperature when the battery is not charging.

3. The electric vehicle of claim 2, wherein the heating and cooling system further comprises:
an evaporator disposed within the battery housing;
an expansion valve;
a condenser disposed outside of the passenger compartment;
an electrical compressor disposed outside of the passenger compartment; and
a refrigerant circuit containing a refrigerant and coupled to the evaporator, the expansion valve, the condenser, and the electrical compressor.

4. The electric vehicle of claim 3 wherein the controller is configured to control the compressor to cool the traction battery during charging.

5. The electric vehicle of claim 4 wherein the passenger compartment comprises at least four rows of passenger seats.

6. The electric vehicle of claim 5 wherein the electric heating element comprises a positive temperature coefficient (PTC) heating element.

7. The electric vehicle of claim 6 wherein the controller is configured to maintain traction battery temperature range between 10 and 25 degrees Celsius.

8. The electric vehicle of claim 7 wherein the traction battery has a mass of at least 1,000 kg.

9. The electric vehicle of claim 1 wherein the passenger compartment is only supplied with heat or cold from the traction battery.

10. A method for controlling an electric vehicle having a traction battery disposed within an insulated housing, which is disposed within an insulated passenger compartment, comprising:
operating, by a controller, a heating and cooling system to use thermal capacity of the traction battery to heat and cool the passenger compartment, the heating and cooling system comprising a first heat exchanger disposed outside the housing and a second heat exchanger disposed within the housing, a circulating pump, and a fluid circuit coupling the first and second heat exchangers and containing a liquid circulated by the pump, the system further comprising a heating element coupled to the fluid circuit and operated by the controller to selectively heat the liquid, an evaporator/condenser and an expansion valve coupled by a refrigerant circuit to an electric compressor selectively operated by the controller to cool the liquid.

11. The method of claim 10 wherein the heating and cooling system further comprises a blower configured to circulate air through the first heat exchanger, wherein the controller is configured to operate the blower to condition the passenger compartment when the traction battery is not charging.

12. The method of claim 10 wherein the controller operates the heating and cooling system to maintain temperature of the traction battery between 10 and 25 degrees Celsius.

13. The method of claim 10 wherein the controller operates the compressor during charging of the traction battery.

14. The method of claim 10 wherein the evaporator/condenser is disposed within the housing.

15. The method of claim 10 wherein the controller is configured to operate the heating and cooling system to maintain temperature of the traction battery between 4 and 35 degrees Celsius.

16. A battery electric vehicle, comprising:
a thermally insulated passenger compartment;
a traction battery contained within a thermally insulated battery housing, the battery housing disposed within the thermally insulated passenger compartment;
a heating and cooling system configured to heat and cool both the traction battery and the passenger compartment, comprising:
an electric heating element;
a first heat exchanger disposed outside of the battery housing;
a blower motor configured to circulate air within the passenger compartment through the first heat exchanger;
a second heat exchanger disposed within the battery housing;
a fluid circuit coupled to the first and second heat exchangers and the electric heating element;
a circulating pump configured to circulate a liquid through the fluid circuit;
an evaporator;
an expansion valve;
a condenser;
an electrical compressor; and
a refrigerant circuit containing a refrigerant and coupled to the evaporator, the expansion valve, the condenser, and the electrical compressor;
and;
a controller configured to control the electric heating element, the blower motor, the circulating pump, and the compressor of the heating and cooling system to warm or cool air within the passenger compartment using thermal capacity of the traction battery.

17. The battery electric vehicle of claim 16 wherein the evaporator is disposed within the battery housing.

18. The battery electric vehicle of claim 17 wherein the condenser is disposed outside of the passenger compartment.

19. The battery electric vehicle of claim 18 wherein the electrical compressor is disposed outside the passenger compartment.

20. The battery electric vehicle of claim 19 wherein the controller is further configured to operate the heating and cooling system to maintain temperature of the traction battery between 4 and 35 degrees Celsius.
